(19) United States
(12) Patent Application Publication
(10) Pub. No.: US 2007/0065624 A1
(43) Pub. Date: Mar. 22, 2007

(54) Optical recording medium

(75) Inventors: Kazuki Matsumoto, Kawasaki-shi (JP); Rumiko Hayase, Yokohama-shi (JP); Norikatsu Sasao, Tokyo (JP); Akiko Hirao, Chiba-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/521,346

(22) Filed: Sep. 15, 2006

(30) Foreign Application Priority Data
Sep. 15, 2005 (JP) P.2005-268980

(51) Int. Cl. B32B 3/02

(52) U.S. Cl. 428/64.4

(57) ABSTRACT

An optical recording medium is provided and includes: a recoding layer; and a reproduction control layer on an light incidence side of the recording layer, the reproduction control layer including a photopolymerization initiator and a photopolymerizable compound.

The present application claims foreign priority based on Japanese Patent Application No. JP2005-268980 filed on Sep. 15 of 2005, the contents of which is incorporated herein by reference.

### FIELD OF THE INVENTION

This invention relates to an optical recording medium.

### BACKGROUND OF THE INVENTION

Optical discs, in which records are reproduced by irradiating the optical discs with photo beams, have favorable characteristics such as high capacity, high-speed access and convenience in portability and can be economically manufactured. Owing to these merits, optical discs have been widely used in recording and distributing data and so on. Among them, optical discs of the read-only type typified by CD-ROMs (compact disc-read-only memories) and DVD-ROMs (digital versatile disc-read-only memories) are suitable for the mass distribution of the same contents such as programs, music softwares and video softwares.

However, the mass distribution of these contents brings about unlimited data diffusion, illegal copying and so on and thus causes serious problems in copyright protection.

To solve the problems of unlimited data diffusion, illegal copying and so on, there have been proposed optical discs with limitation to the reproduction (audiovisual) time and number. As a typical example thereof, a DVD product “EZ-D (trade name)” marketed by Flexplay Technologies, USA may be cited (see Flexplay Technologies, “Flexplay” (online), (searched for on Sep. 2, 2005)

<URL:http://www.flexplay.com>,

<URL:http://www.flexplay.com/how-flexplay-works.htm>).

The characteristic of the reproduction-controlling technique employed in “EZ-D (trade name)” resides in using a dye which reacts with oxygen and turns into black in the substrate. Before reproduction, the optical disc is sealed in a package having an oxygen-barrier function. When the seal is broken before reproduction, oxygen penetrates into the optical disc. As the oxygen penetrates, the dye turns into black and absorbs the reproduction light wavelength (650 nm) of the DVD. As a result, it becomes impossible to take out the data stored in the recording layer. In “EZ-D (trade name)”, therefore, the reproduction time after breaking the seal is determined depending on the diffusion speed of oxygen contained in the substrate.

From the viewpoints of mechanical strength and required transcriptional performance, however, a substrate material through which oxygen can diffuse within several hours can be hardly found. In the technique employed in “EZ-D (trade name)”, therefore, the reproduction time can be controlled only at a rough level of several ten hours but more strict control (i.e., reproduction time of several hours or reproduction number of several times) cannot be made.

### SUMMARY OF THE INVENTION

According to an illustrative, non-limiting embodiment of the invention, an optical recording medium includes: a recoding layer; and a reproduction control layer on an light incidence side of the recording layer, the reproduction control layer comprising a photopolymerization initiator and a photopolymerizable compound.

According to an illustrative, non-limiting embodiment of the invention, an optical recording medium excellent in reproduction control can be provided.

### BRIEF DESCRIPTION OF THE INVENTION

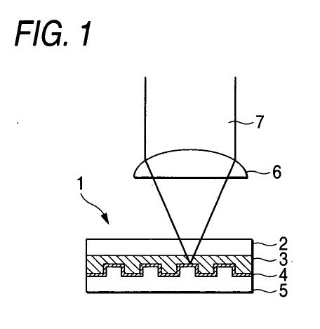

FIG. 1 is a sectional model view of an optical recording medium according to an exemplary embodiment.

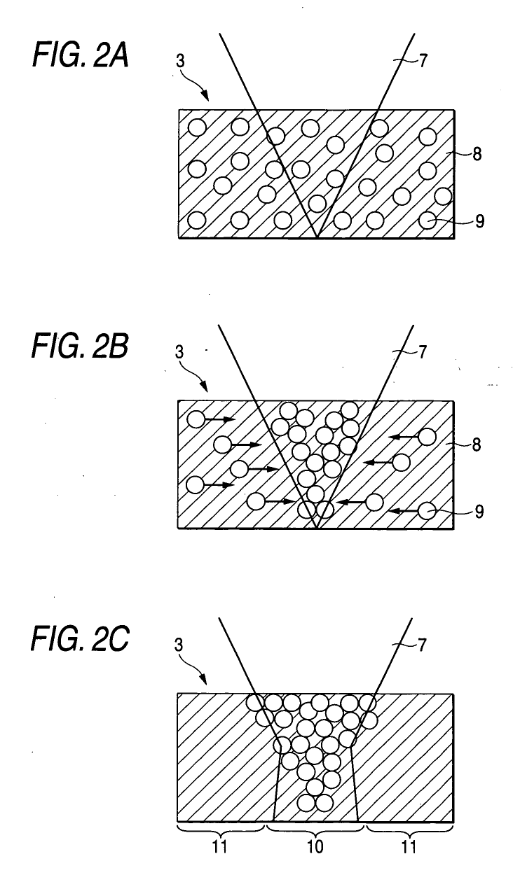

FIGS. 2A to 2C are model views illustrating a reproduction-controlling mechanism of a reproduction control layer 3.

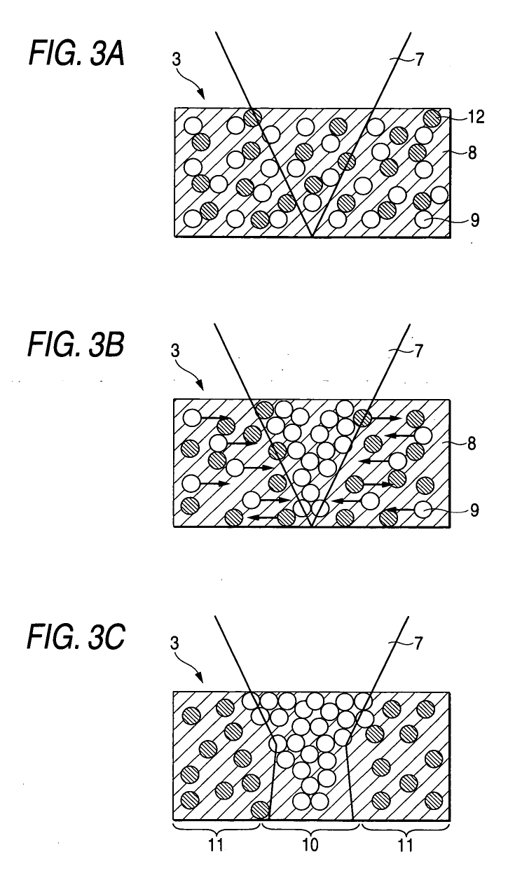

FIG. 3A to 3C are model views illustrating a reproduction-controlling mechanism of a reproduction control layer 3 in the case of containing a binder.

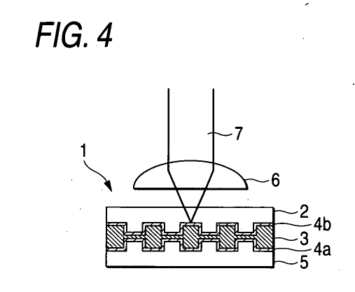

FIG. 4 is a sectional model view of an optical recording medium of the bonding type.

### DETAILED DESCRIPTION OF THE INVENTION

Next, exemplary embodiments will be described by referring to drawings. The same numeral or sign is assigned to a member commonly employed throughout these embodiments and duplicated description is omitted. These drawings are model views presented for illustrating embodiments and promoting the understanding. Although some shapes, sizes, ratios, etc. in these drawings differ from those employed in devices in practice, modifications and variations can be appropriately made by taking the following description and publicly known techniques into consideration.

Although blue laser DVDs will be mainly illustrated hereinbelow, the scope of the invention is not restricted thereto but it is applicable to red laser DVDs and other optical recording media such as hologram recording media.

Concerning the photopolymerization initiator and the photopolymerizable compound contained in the reproduction control layer, compounds which are sensitive to reproduction light will be illustrated. However, the invention is not restricted thereto but use can be made of photopolymerization initiators and photopolymerizable compounds sensitive to light entering the optical recording medium such as servo light.

Now, an exemplary embodiment will be roughly described.

An optical recording medium of the embodiment has a reproduction control layer whereby reproduction by the optical recording medium can be controlled. This reproduction control layer is characterized by being formed in a light incidence side of a recording layer that records the data therein and containing a photopolymerization initiator and a photopolymerizable compound sensitive to reproduction light.

According to the embodiment, the photopolymerization initiator in the reproduction control layer absorbing the reproduction light generates active species such as radicals and cations upon reproduction of the data. These active species induce the photopolymerization of the photopolymerizable compound. The photopolymerization brings about refractive index distribution and transmittance distribution. Due to these distributions, light scatters and the reproduction performance is thus worsened. Thus, the reproduction time and number can be limited and the reproduction control layer can control reproduction thereby.

By using this reproduction-controlling technique, the reproduction time can be minutely controlled by altering the composition of the photopolymerization initiator or the photopolymerizable compound.

Since light scattering is employed in controlling reproduction in the embodiment, the reproduction can be controlled by using a thin reproduction control layer having a thickness of 0.01 mm to 0.05 mm. The layer thickness of the reproduction control layer can be enlarged so long as the reproduction performance is not worsened thereby. In the case of a double-layered optical disc having a bonded structure as FIG. 4 shows, for example, the layer thickness can be elevated up to 0.6 mm. In the case of a single-layered optical disc as shown in FIG. 1, the layer thickness can be elevated up to 0.1 mm.

In “EZ-D (trade name)”, in contrast thereto, a dye is contained in a substrate of about 600 μm in thickness. In general, a change in the reproduction light absorptivity of a dye before and after reaction and the content of the dye in a substrate are restricted. In the reproduction-controlling technique to be used in “EZ-D (trade name)”, therefore, it is considered that the layer containing the dye should have a thickness of several hundred μm.

In the embodiment, use can be made of a package capable of blocking the reproduction light by scattering. Thus, additives such as a dye may be used therein only in a small amount, which enables a simple constitution.

In “EZ-D (trade name)”, in contrast thereto, a package having an oxygen-barrier function is essentially required before reproduction.

In a DVD or an HD-DVD which is an optical disc using the bonding system, the photopolymerizable compound may be dispersed in the intermediate (bonding) layer so as to impart the reproduction-controlling function to the bonding layer. In this case, members with a large number of requirements (for example, a substrate, a recording layer, and so on.) are less affected. That is, the embodiment is excellent in the compatibility with existing members.

Next, an exemplary embodiment will be described in greater detail by referring to FIG. 1.

FIG. 1 is a sectional model view showing an example of the embodiment.

An optical recording medium 1 has a layered structure including, from the bottom, a substrate 5, a reflective layer 4, a reproduction control layer 3 and a protective layer 2 transparent to reproduction light. In the substrate, data have been preliminarily stored owing to its microasperity pattern. The reflective layer 4 is formed so as to follow up the microasperity pattern of the substrate 5. Reproduction of the data is conducted by irradiating the reflective layer 4 with the reproduction light 7 by using an objective lens 6. Since the reproduction control layer 3 is formed in the light incidence side of the reflective layer 4 recording the data, it is irradiated with the reproduction light 7. In this case, the reflective layer 4 serves as a recording layer.

Examples of the material of the substrate 5 include glass, polycarbonate resins, polyolefin resins, polyimide resins, polyethylene resins, epoxy resins, polymethacrylate resins and combinations thereof. From the viewpoints of optical characteristics and mechanical strength, it is preferable that the thickness of the substrate ranges from about 0.3 to 1.2 mm, though the invention is not restricted thereto. Data recording by the microasperity pattern of the substrate 5 may be conducted by, using, for example, injection molding with the use of a metal stamper, imprinting, the 2P technique with the use of a glass stamper and son on, though the invention is not restricted thereto.

Examples of the material of the protective layer 2 are the same as those cited above concerning the substrate 5. In the case of forming the protective layer 2, it is preferable from the viewpoints of optical characteristics and mechanical strength that the thickness thereof ranges from about 0.1 to 1.2 mm, though the invention is not restricted thereto.

The reproduction control layer 3 contains a photopolymerization initiator and a photopolymerizable compound sensitive to the reproduction light. The photopolymerization initiator is a compound which absorbs light and induces the photopolymerization of the photopolymerizable compound. The photopolymerizable compound is a compound which undergoes polymerization under the action of the photopolymerization initiator to cause changes in optical characteristics such as refractive index and transmittance. Those generally called photopolymers may be cited as illustrative examples thereof.

In addition to the photopolymerization initiator and the photopolymerizable compound, it is preferable that the reproduction control layer 3 contains a compound which has adhesiveness and contributes to the retention of volume.

Similar to reflective film materials generally used in optical discs, the reflective layer 4 may be made of a metal such as gold, silver or aluminum or an alloy containing these metals.

Now, a reproduction-controlling mechanism of the embodiment will be described by referring to FIGS. 2A to 2C.

FIGS. 2A to 2C are model views for illustrating a reproduction-controlling mechanism of a reproduction control layer 3.

As FIG. 2A shows, the reproduction control layer 3 contains a compound 8 contributing to the volume-retention (a three-dimensionally crosslinked polymer matrix structure is indicated in FIGS. 2A to 2C) and a photopolymerizable compound 9. Reproduction light 7 is collected on the surface of the reflective layer (not shown in the figure) located at the bottom of this reproduction control layer 3.

As FIG. 2B shows, polymerization of the photopolymerizable compound 9 arises at a part which is irradiated with the reproduction light at a high intensity. Then, the photopolymerizable compound 9 is supplied from a part where the reproduction light intensity is low to a part where the reproduction light intensity is high via diffusion.

As FIG. 2C shows, the photopolymerization and supply via diffusion of the photopolymerizable compound 9 are repeated and, as a result, a high-refractive index part 10 and a low-refractive index part 11 are formed within the reproduction control layer 3. Owing to this spatial distribution of refractive index, the reproduction light 7 scatters and thus the reproduction performance is worsened.

Next, materials to be used in the reproduction control layer 3 will be discussed in detail.

In addition to the photopolymerization initiator, the photopolymerizable compound and the compound contributing to the volume-retention, it is preferable that the reproduction control layer 3 contains a binder and so on. Next, the photopolymerization initiator, the photopolymerizable compound, the compound contributing to the volume-retention and the binder will be described in this order.

(Photopolymerization Initiator)

A photopolymerization initiator is a compound which can generate active species such as radicals or cations and thus induce the photopolymerization of a photopolymerizable compound.

As the photopolymerization initiator, a photo radical polymerization initiator is used for a radical polymerizable compound while a photo cation polymerization initiator is used for a photo cation polymerizable compound. Namely, an appropriate photopolymerization initiator is selected depending on the wavelength of the reproduction light.

Examples of the photo radical polymerization initiator include benzyl, benzoin, benzoin ethyl ether, benzoin isopropyl ether, benzoin butyl ether, benzoin isobutyl ether, 1-hydroxycyclohexyl phenyl ketone, benzyl methyl ketal, benzyl ethyl ketal, benzyl methoxyethyl ether, 2,2′-diethylacetophenone, 2,2′-dipropylacetophenone, 2-hydroxy-2-methylpropiophenone, p-tert-butyltrichloroacetophenone, thioxanthone, 1 -chlorothioxanthone, 2-chlorothioxanthone, 2-methylthioxanthone, 2-isopropylthioxanthone, 3,3′,4,4′-tetra(t-butylperoxycarbonyl)benzophenone, 2,4,6-tris(trichloromethyl) 1,3,5-triazine, 2-(p-methoxyphenyl)-4,6-bis(trichloromethyl) 1,3,5-triazine, 2-[(p-methoxyphenyl)ethylene]-4,6-bis(trichloromethyl) 1,3,5-triazine, diphenyl-(2,4,6-trimethylbenzoyl)phosphine oxide, Irgacure Nos. 149, 184, 369, 651, 784, 819, 907, 1700, 1800, 1850 and so on manufactured by Ciba Specialty Chemicals, di-t-buty peroxide, dicumyl peroxide, t-butylcumyl peroxide, t-butyl peroxyacetate, t-butyl peroxyphthalate, t-butyl peroxybenzoate, acetyl peroxide, isobutyryl peroxide, decanoyl peroxide, lauroyl peroxide, benzoyl peroxide, t-butyl hydroperoxide, cumene hydroperoxide, methyl ethyl ketone peroxide, cyclohexanone peroxide and so on.

In the case where the reproduction light is blue semiconductor laser, it is suitable from the viewpoint of absorptivity, radical generation efficiency, etc. to use Irgacure No. 369, Irgacure No. 784 (Ciba Specialty Chemicals), diphenyl-(2,4,6-trimethylbenzoyl)phosphine oxide, etc. from among the photo radical polymerization initiators as cited above. In the case where the photo radical polymerization initiator has a low absorptivity to the reproduction light wavelength, it is also possible to add a sensitizing dye to thereby elevate the sensitivity at the reproduction light wavelength.

As examples of the photo cation polymerization initiator, onium salts, diphenyliodonium salts, triphenylphosphonium salts, tetarallylsulfonium salt and so on. In the case where the photo cation polymerization initiator has a small absorption coefficient to the reproduction light wavelength, it is also possible to add a sensitizing dye to thereby elevate the sensitivity at the reproduction light wavelength.

(Photopolymerizable Compound)

Examples of the photopolymerizable compound include radical polymerizable compounds and cation polymerizable compounds.

Examples of the radical polymerizable compounds include compounds having at least one ethylenically unsaturated bond.

More specifically speaking, examples of thereof include unsaturated carboxylic acids, unsaturated carboxylic acid esters, unsaturated carboxylic acid amides, vinyl compounds and so on. Particular examples thereof include acrylic acid, methyl acrylate, ethyl acrylate, propyl acrylate, butyl acrylate, isobutyl acrylate, 2-ethylhexyl acrylate, octyl acrylate, lauryl acrylate, stearyl acrylate, cyclohexyl acrylate, bicyclopentenyl acrylate, phenyl acrylate, 2,4,6-tribromophenyl acrylate, isobornyl acrylate, adamantyl acrylate, methacrylic acid, methyl methacrylate, propyl methacrylate, butyl methacrylate, phenyl methacrylate, phenoxyethyl acrylate, chlorophenyl acrylate, adamantyl methacrylate, isobornyl methacrylate, N-methyl acrylamide, N,N-dimethyl acrylamide, N,N-mehylene bisacrylamide, acryloyl morpholine, vinyl pyridine, styrene, bromostyrene, chlorostyrene, tribromophenyl acrylate, trichlorophenyl acrylate, tribromophenyl methacrylate, trichlorophenyl methacrylate, vinyl benzoate, 3,5-dichlorovinyl benzoate, vinyl naphthalene, vinyl naphthoate, naphthyl methacrylate, naphthyl acrylate, N-phenyl methacrylamide, N-phenyl acrylamide, N-vinyl pyrrolidinone, N-vinyl carbazole, 1-vinyl imidazole, bicyclopentenyl acrylate, 1,6-hexanediol diacrylate, pentaerythritol triacryalte, pentaerythritol tetraacrylate, dipentaerythritol hexaacrylate, diethylene glycol diacrylate, polyethylene glycol diacrylate, polyethylene glycol dimethacrylate, tripropylene glycol diacrylate, propylene glycol trimethacrylate, diallyl phthalate, triallyl trimeritate and so on.

From the viewpoints of volume-retention and adhesiveness, it is preferred that the content of the radical polymerizable compound in the reproduction control layer is 20% by weight or less. Either one of the above-described radical polymerization compounds or a mixture thereof may be used.

Examples of the cation polymerizable compound include epoxy, oxetane, isobutene, styrene, α-methyl styrene, vinyl ether, N-vinyl carbazole and so on.

(Compound Having Adhesiveness and Contributing to the Volume-Retention)

Examples of the compound having adhesiveness and contributing to the volume-retention include inorganic materials such as sol gel glass and organic materials such as heat polymerizable compounds, thermoplastic polymers.

Examples of the heat polymerizable compounds include compounds formed by heat polymerization, as will be described hereinbelow.

Namely, citation may be made of epoxy-amine step polymerization, epoxy-acid anhydride step polymerization, epoxy-mercaptan step polymerization, unsaturated ester-amine step polymerization (via Michael addition), unsaturated ester-mercaptan step polymerization (via Michael addition), vinyl-silicon hydride step polymerization (hydrosilylation), isocyanate-hydroxyl step polymerization (urethane formation) and isocyanate-amine step polymerization (urea formation).

Among them, a cured resin obtained by reacting an epoxy compound with a curing agent is suitable because of being excellent in compatibility with existing materials, constitutions, etc.

Examples of the epoxy compound include 1,4-butanediol diglycidyl ether, 1,6-hexanediol diglycidyl ether, diethylene glycol diglycidyl ether, polyethylene glycol diglycidyl ether, polypropylene glycol diglycidyl ether, neopentyl glycol diglycidyl ether, diepoxyoctane, resorcinol diglycidyl ether, diglycidyl ether of bisphenol A, diglycidyl ether of bisphenol F, 3,4-epoxycyclohexenylmethyl-3′,4′-epoxycyclohexene carboxylate, polydimethylsiloxane at the epoxypropoxypropyl end and so on.

As the compound capable of curing the epoxy compound (i.e., the curing agent), citation may be made of amines, phenols, organic acid anhydrides and amides having been known as epoxy-curing agents may be cited. Specific examples thereof include ethylenediamine, diethylenetriamine, triethylenetetramine, tetraethylenepentamine, pentaethylenehexamine, hexamethylenediamine, menthenediamine, isophorondiamine, bis(4-amino-3-methyldicyclohexyl)methane, bis(aminomethyl)cyclohexane, N-aminoethylpiperazine, m-xylylenediamine, 1,3-diaminopropane, 1,4-diaminobutane, trimethylhexamethylenediamine, iminobispropylaamine, bis(hexamethylene)triamine, 1,3,6-trisaminomethylhexane, dimethylaminopropylamine, aminoethyl ethanolamine, tri(methylamino)hexane, m-phenylenediamine, p-phenylenediamine, diaminodiphenylmethane, diaminodiphenylsulfone, 3,3′-diethyl-4,4′-diaminodiphenylmethane, maleic anhydride, succinic anhydride, tetrahydrophthalic anhydride, methyltetrahydrophthalic anhydride, methylnadic anhydride, hexahydrophthalic anhydride, methylhexahydrophthalic acid, methylcyclohexenetetracarbonic anhydride, phthalic anhydride, trimellitic anhydride, benzophenonetetracarbonic anhydride, dodecenylsuccinic anhydride, ethylene glycol bis(anhydrotrimellitate), phenol novolak resin, cresol novolak resin, polyvinyl phenol, terpene phenol resin, polyamide resin and so on.

To form a three-dimensionally crosslinked polymer matrix structure highly contributing to volume-retention, it is preferable to employ a curing agent having three or more reaction sites.

Examples of the thermoplastic polymer include vinyl acetate-base resins, polyvinyl alcohol-base resins, polyvinylacetal-base resins, acrylic resins, polyamide-base resins, polyethylene-base resins, polystyrene-base resins, vinyl chloride-base resins and so on.

(Binder)

A binder plays a role of lessening volume change. Depending on the refractive index, moreover, it can make the spatial distribution of refractive index obvious to thereby contribute to reproduction control with elevated fineness.

Now, the reproduction-controlling mechanism in the case where the reproduction control layer contains a binder will be illustrated by referring to FIGS. 3A to 3C.

FIGS. 3A to 3C are model views which illustrate the reproduction-controlling mechanism in the case of containing a binder.

As FIG. 3A shows, a reproduction control layer 3 contains a compound 8 contributing to volume-retention (a three-dimensionally crosslinked polymer matrix structure is herein), a photopolymerizable compound 9 and a binder 12. Reproduction light 7 is collected to the surface (not shown in the drawing) of a reflective layer 4 located at the bottom of the reproduction control layer 3.

As FIG. 3B shows, polymerization of the photopolymerizable compound 9 arises at a part which is irradiated with the reproduction light 7 at a high intensity. Then, the photopolymerizable compound 9 is supplied from a part where the reproduction light intensity is low to a part where the reproduction light intensity is high via diffusion. On the contrary, the binder 12 is pushed out by the photopolymerizable compound 9 and thus migrates toward the part where the reproduction light intensity is low.

As FIG. 3C shows, the photopolymerization of the photopolymerizable compound 9 and the migration of the binder 12 are and, as a result, a high-refractive index part 10 and a low-refractive index part 11 are formed within the reproduction control layer 3. Owing to this spatial distribution of refractive index, the reproduction light 7 scatters and thus the reproduction performance is worsened. Since the binder 12 migrates toward a part where the photopolymerizable compound 9 is reduced, the volume change of the reproduction control layer 3 can be thus lessened.

FIGS. 3A to 3C shows a case where the binder 12 has a lower refractive index than the photopolymerizable compound 9 after the polymerization.

As the binder, an organic compound being inactive during the reproduction or inorganic fine particles are employed.

Such an organic compound should be inactive at least to the reproduction light. In the case where the reproduction control layer 3 contains a radical polymerizable compound, it should be inactive to radicals. In the case where the reproduction control layer 3 contains a cation polymerizable compound, it should be inactive to cations.

It is preferable that the organic compound to be used as the binder has a large difference in refractive index compared with the photopolymerizable compound. Examples of a compound having a lower refractive index than the photopolymerizable compound include fluorine compounds and dimethyl suberimidate and so on. Examples of a compound having a higher refractive index than the photopolymerizable compound include aromatic sulfur compounds, aromatic halogen compounds, phenyl naphthalene and so on.

Examples of the inorganic fine particles to be used as the binder include metal oxides such as Sio₂, TiO₂, Al₂O₃ and so on. It is preferable that these inorganic fine particles have a spherical shape with a diameter corresponding to ⅕ or less of the reproduction light wavelength, since little light scattering is caused thereby.

Next, the case where the reproduction control layer 3 contains no compound contributing to volume-retention will be described.

A photopolymerizable compound is a material which has adhesion properties as well as reproduction-controlling ability and the adhesiveness of which is improved by photopolymerization. In the course of production, the entire face is irradiated with light and a portion of the photopolymerizable compound is polymerized, thereby imparting adhesiveness to the reproduction control layer 3. The polymerization is conducted while avoiding light scattering. At the step of reproduction, the remainder of the photopolymerizable compound is polymerized so as to control the reproduction.

In forming the reproduction control layer 3, light irradiation is required to achieve a hardness sufficient for volume-retention. In polymerization, however, chain polymerization reaction generally proceeds even after ceasing the light irradiation. Therefore, the polymerization likely proceeds in excess in the reproduction step. In this case, the reproduction-controlling performance is worsened.

In the case where the reproduction control layer 3 contains no compound contributing to volume-retention, therefore, it is desirable to add a polymerization inhibitor for rapidly stopping the polymerization reaction after the light irradiation aiming at volume-retention.

Since no appropriate polymerization inhibitor is available for cation polymerizable compounds, it is desirable to employ a radical polymerizable compound as the photopolymerizable compound.

Examples of the polymerization inhibitor usable for radical polymerizable compounds include hydroquinones such as hydroquinone, p-t-butyl catechol, mono-t-butyl hydroquinone, hydroquinone monomethyl ether, phenols such as di-p-cresol, quinones such as p-benzoquinone, naphthoquinone and p-toluquinone, copper naphthene and so on.

In this case, it is more preferable that the radical polymerizable compound forms a three-dimensionally crosslinked polymer matrix. For this purpose, it is still preferable that the precursor of the reproduction control layer 3 contains a compound having two or more ethylenically unsaturated bonds. Specific examples thereof include 1,6-hexanediol diacrylate, pentaerythritol triacrylate, pentaerythritol tetraacrylate, dipentaerythritol hexaacrylate, diethylene glycol diacrylate, polyethylene glycol diacrylate, polyethylene glycol dimethacrylate, tripropylene glycol diacrylate, propylene glycol trimethacrylate, diallyl phthalate, triallyl trimellitate and so on.

### MODIFICATION EXAMPLE

The invention is also usable in a multilayered optical recording medium.

FIG. 4 is a sectional view showing a case of applying the invention to a single-side double-layered optical recording medium of the bonding type.

As FIG. 4 shows, an optical recording medium 1 has a transparent substrate 2 and a substrate 5 wherein data have been preliminarily recorded owing to the microasperity patterns. A reflective layer 4a and a semitransparent layer 4b, by which reproduction light is partly reflected and penetrates therethrough, are formed respectively following the microasperity patterns of the substrate 5 and the transparent substrate 2. A reproduction control layer 3 is formed between the reflective layer 4a and the semitransparent layer 4b.

As the materials having the transparent substrate 2 and the substrate 5 and constituting the reflective layer 4a and the reproduction control layer 3, use may be made of the same materials as employed in the optical recording medium shown in FIG. 1. The semitransparent layer 4b is made up of a film comprising a metal such as gold, silver or aluminum or an alloy containing the same or an oxide such as SiO₂, TiO₂, Al₂O₃ or ZiO or a multilayer membrane containing the same.

In the case of applying the invention to an optical disc of the bonding system as described above, it is possible to impart the reproduction-controlling ability to the so-called bonding layer. This is favorable since a high compatibility with other constituting members can be thus established.

Upon the reproduction of data stored in this optical recording medium, the reproduction control layer undergoes photopolymerization due to the reproduction light as described above and causes light scattering. As a result, the data having been preliminarily recorded on the substrate 5 cannot be reproduced any more. On the other hand, the data having been preliminarily recorded on the transparent substrate 2 can be reproduced since the reproduction light does not pass through the reproduction control layer 3. In the case of applying the invention to a multilayered recording medium, therefore, the data stored in the recording layer in the reproduction light incidence side cab be reproduced, even though the reproduction control layer exerts its function.

Accordingly, there is proposed the following system for restricting the reproduction of the data having been recorded in the first layer in the incidence side by using the reproduction control layer. Namely, a read-in area for recording track data and session data is formed in the second layer or thereafter. The data in the first layer are encoded and then code keys required in decoding are recorded in the second layer or thereafter. Thus, serial data are alternately recorded in these multiple recording layers.

Although optical recording media are in the shapes of discs, cards and so on, the shape of the optical recording medium of the invention is not restricted thereto.

Although the invention will be described by referring to the following Examples, it is to be understood that the invention is not restricted to the following Examples without departing from the spirit thereof.

### Example 1

In this Example, an optical recording medium 1 shown in FIG. 1 was fabricated by the following method.

<Preparation of Reproduction Control Layer Precursor>

First, 3.86 g of N-vinyl carbazole employed as a radical polymerizable monomer was mixed with 0.19 g of diphenyl-(2,4,6-trimethylbenzoyl)phosphine oxide employed as a photo radical polymerization initiator and the resultant mixture was stirred to give a monomer solution A. Next, 10.1 g of 1,4-butanediol diglycidyl ether employed as an epoxy compound was mixed with 3.6 g of diethylene triamine employed as a curing agent to give an epoxy solution B. 1.5 ml of the monomer solution A was mixed with 8.5 ml of the epoxy solution B and defoamed to give a reproduction control layer precursor.

<Construction of Substrate and Reflective Film>

A disc-shaped polycarbonate substrate (thickness: 0.6 mm) in which 8/16 modulated signals were formed with micropits (track width: 0.37 μm) was injection-molded with a metal stamper. Then, an aluminum film (thickness: 100 nm) was formed thereon as a reflective layer by magnetron sputtering.

<Formation of Optical Recording Medium>

Next, the reproduction control layer precursor was applied by the spin coating method on the face having the modulated signals recorded therein of the polycarbonate substrate to give a thickness of 20 μm. After placing a dummy substrate (thickness: 0.6 mm) having no modulated signal thereon and closely bonding, it was cured by heating in a thermostat at 60° C. for 2 hours to give an optical recording medium.

These operations were conducted in a room in which light beams having wavelengths shorter than 500 nm were blocked so as to prevent the recording area 4 from light exposure.

<Evaluation of Reproduction-Controlling Performance>

<First Reproduction>

Evaluation was conducted by using an optical disc evaluation device provided with an objective lens having a numerical aperture (NA) of 0.65 and a semiconductor laser of 405 nm in wavelength. By adjusting the reproduction light intensity to 0.8 mW, the first reproduction by the above-described optical recording medium was evaluated. As a result, the jitter was 6.0%, indicating favorable reproduction performance.

<Second Reproduction and Thereafter>

After the first reproduction, the reproduction evaluation was conducted four times at intervals of 10 minutes. Table 1 shows the jitters in individual evaluation times. Thus, the signal jitter increased at the third reproduction and thereafter and thus the data reproduction became impossible.

TABLE 1

| | Jitter | Reproduction performance |
|---|---|---|
| First time | 6.00% | A |
| Second time | 10.10% | B |
| Third time | 14.40% | C |
| Fourth time | 15.00% | C |
| Fifth time | 15.10% | C |

### Example 2

In this Example, an optical recording medium was fabricated by the following method.

<Preparation of Reproduction Control Layer Precursor>

A reproduction control layer precursor was prepared as in other Examples.

<Construction of Substrate and Reflective Film>

A disc-shaped polycarbonate substrate (thickness: 1.1 mm) in which 8/16 modulated signals were formed with micropits (track width: 0.37 μm) was injection-molded with a metal stamper. Then, an aluminum film (thickness: 100 nm) was formed thereon as a reflective layer by magnetron sputtering.

<Formation of Optical Recording Medium>

Next, the reproduction control layer precursor was applied by the spin coating method on the face having the modulated signals recorded therein of the polycarbonate substrate to give a thickness of 20 μm. After placing a polycarbonate film (thickness: 0.1 mm) thereon and closely bonding, it was adhered by heating in a thermostat at 60° C. for 2 hours.

These operations were conducted in a room in which light beams having wavelengths shorter than 500 nm were blocked so as to prevent the recording area 4 from light exposure.

<Evaluation of Reproduction-Controlling Performance>

Evaluation was conducted by using an optical disc evaluation device provided with an objective lens having a numerical aperture (NA) of 0.85 and a semiconductor laser of 405 nm in wavelength. By adjusting the reproduction light intensity to 0.8 mW, the reproduction by the above-described optical recording medium was evaluated several times. Table 2 shows the results.

TABLE 2

| | Jitter | Reproduction performance |
|---|---|---|
| First time | 5.20% | A |
| Second time | 12.30% | B |
| Third time | 15.40% | C |
| Fourth time | 16.00% | C |
| Fifth time | 16.10% | C |

### Example 3

In this Example, an optical recording medium 1 was fabricated by the following method. The optical recording medium 1 fabricated herein can be explained by referring to the sectional model view of FIG. 1 omitting the recording layer 2.

<Preparation of Reproduction Control Layer Precursor>

First, 3.5 g of N-vinyl carbazole employed as a radical polymerizable monomer was mixed with 0.36 g of diethylene glycol diacrylate, 0.18 g of diphenyl-(2,4,6-trimethylbenzoyl)phosphine oxide employed as a photo radical polymerization initiator and 0.01 g of hydroquinone employed as a radical polymerization inhibitor and the resultant mixture was stirred to give a reproduction control layer precursor.

<Construction of Substrate and Reflective Film>

A disc-shaped polycarbonate substrate (thickness: 0.6 mm) in which 8/16 modulated signals were formed with micropits (track width: 0.37 μm) was injection-molded with a metal stamper. Then, an aluminum film (thickness: 100 nm) was formed thereon as a reflective layer by magnetron sputtering.

<Formation of Optical Recording Medium>

Next, the reproduction control layer precursor was applied by the spin coating method on the face having the modulated signals recorded therein of the polycarbonate substrate to give a thickness of 20 μm. Then, the entire face of the substrate was uniformly irradiated with a light-emitting diode array (central wavelength: 407 nm, total output: 100 mW) for 5 seconds. After placing a dummy substrate (thickness: 0.6 mm) having no modulated signal thereon and closely bonding, it was cured by allowing to stand in a dark place at room temperature for 2 hours to give an optical recording medium.

<Formation of Optical Recording Medium>

Next, the reproduction control layer precursor was applied by the spin coating method on the face having the modulated signals recorded therein of the polycarbonate substrate to give a thickness of 100 μm. After closely bonding a smooth polycarbonate plate thereto to condition the medium surface, it was cured by heating in a thermostat at 60° C. for 2 hours and the polycarbonate plate was finally peeled off to give an optical recording medium.

These operations were conducted in a room in which light beams having wavelengths shorter than 500 nm were blocked so as to prevent the recording area 4 from light exposure.

<Evaluation of Reproduction-Controlling Performance>

Evaluation was conducted by using an optical disc evaluation device provided with an objective lens having a numerical aperture (NA) of 0.65 and a semiconductor laser of 405 nm in wavelength. By adjusting the reproduction light intensity to 0.8 mW, the reproduction by the above-described optical recording medium was evaluated several times. Table 3 shows the results.

TABLE 3

| | Jitter | Reproduction performance |
|---|---|---|
| First time | 6.30% | A |
| Second time | 10.10% | B |
| Third time | 14.50% | C |
| Fourth time | 15.10% | C |
| Fifth time | 15.20% | C |

Although the modes for carrying out the invention have been described above, the invention is not restricted thereto but variations may be made within its spirit and scope as set forth in the accompanying claims. In embodying the invention, moreover, modifications may be made without departing from the spirit of the invention. Furthermore, various inventions may be made by appropriately combining a plural number of constituting elements disclosed in the above embodiment modes.

What is claimed is:

1. An optical recording medium comprising:
a recoding layer; and
a reproduction control layer on an light incidence side of the recording layer, the reproduction control layer comprising a photopolymerization initiator and a photopolymerizable compound.

2. The optical recording medium according to claim 1, wherein the reproduction control layer comprises at least one of a heat polymerizable compound and a thermoplastic compound.

3. The optical recording medium according to claim 1, wherein the reproduction control layer has a three-dimensionally crosslinked polymer matrix structure.

4. The optical recording medium according to claim 1, wherein the photopolymerization initiator is a photo radical polymerization initiator, and the photopolymerization compound is a photo radical polymerizable compound.

5. The optical recording medium according to claim 1, wherein the photopolymerization initiator is a photo cation polymerization initiator, and the photopolymerization compound is a photo cation polymerizable compound.

6. The optical recording medium according to claim 1, wherein the reproduction control layer comprises a binder.

7. The optical recording medium according to claim 1, wherein the reproduction control layer has a thickness of 0.01 mm to 0.05 mm.

8. The optical recording medium according to claim 1, wherein the reproduction control layer is located between multiple recording layers, and serial data are recorded alternately on the multiple recording layers.
